(19) United States
(12) Patent Application Publication
(10) Pub. No.: US 2008/0211309 A1
(43) Pub. Date: Sep. 4, 2008

(54) Systems and methods for modular battery replacement in aircraft

(76) Inventor: William J. Nolte, San Antonio, TX (US)

Correspondence Address: KAMMER BROWNING PLLC, 7700 BROADWAY, SUITE 202, SAN ANTONIO, TX, 78209, US

(21) Appl. No.: 11/713,463

(22) Filed: Mar. 1, 2007

(51) Int. Cl. H02J 7/00

(52) U.S. Cl. 307/66; 320/134; 320/128

(57) ABSTRACT

A modular aircraft emergency backup battery system and methods for operating the system as well as removing and replacing the modules within the system are described. The system includes a module cabinet enclosure that positions and interconnects the modules. A wiring harness provides the necessary electrical connections to and from the aircraft avionics to recharge the batteries within the system to allow the system to provide a source of power when battery backup is required. The cabinet enclosure provides positioned connections for one or more battery cell modules and one or more power control circuitry modules. A hinged front panel allows access to the battery cell modules and provides a switch and an indicator for operation of a test circuit. The modular enclosure is positioned in place of existing aircraft emergency battery backup systems and connects to the aircraft within the same space.

### BACKGROUND OF THE INVENTION

1. Field of the Invention

The present invention relates generally to aircraft emergency battery backup systems. The present invention relates more specifically to devices and methods for the modular replacement of emergency battery backup system components both on and off the aircraft.

2. Description of the Related Art

Various types of electrical systems are present in most aircraft. In addition to the electrical systems associated with the aircraft engines and electrically operated controls and mechanical devices, most aircraft incorporate electrical/electronic systems that generally include flight instrumentation and the variety of sensors and controls associated with measuring, displaying, and maintaining flight operational parameters, as well as emergency lighting.

As with most land and air vehicles that use internal combustion engines, the drive engines not only generate the forces necessary to propel the vehicles forward, but are typically connected to electrical generators that provide the necessary electrical power to operate the various electrical and electronic systems associated with controlling the vehicles. Initiating the operation of an aircraft engine, as an example, will typically involve an electric starter or the like, powered by one or more aircraft main starting batteries incorporated into the aircraft specifically for this purpose. In addition to maintaining the electrical power necessary to operate the various electrical systems within the aircraft, the engine, by and through the electric generator associated with the engine, will typically recharge the battery utilized for starting the engine. Once the engine is started, however, there is generally little need for an electrical power source to keep the engine running, however there are many electrical devices within an aircraft that operate off of the electricity generated through the turning of the generator by the engine, many of these devices are critical to maintaining safe flight.

The importance of flight critical equipment, however, makes reliance upon the standard basic power generator and battery systems associated with the aircraft engine far too risky for the environments within which the aircraft operates. In other words, it has been found wholly inadequate to rely upon batteries associated with starting the aircraft engine as a basis for maintaining flight critical equipment operation either during powered flight or when engine power is lost. It therefore becomes extremely important to have a battery backup system that is dedicated to the equipment and is not relied upon, or supported by other electrical systems within the aircraft.

Most modern day aircraft, therefore, utilize a battery backup system that is connected to the electrical equipment in the aircraft and which is recharged as necessary by operation of the aircraft's engines, as described above. As a preliminary check or scheduled maintenance check, the status of such an emergency battery backup system is determined and if the system is unable to provide the necessary backup battery power upon engine failure or the like, the battery backup assembly must be removed, serviced, and replaced, thus making the system and aircraft un-airworthy. Federal flight regulations prohibit the operation of aircraft without a positive check on the status of such emergency battery backup systems.

Current emergency battery backup systems are generally configured in several different basic designs depending upon the size of the aircraft and the battery backup system manufacturer. In most cases, however, these systems are fairly well integrated into the electronics compartments associated with an aircraft's avionics equipment. In other words, it is a difficult and time consuming task to remove these battery backup systems, refurbish or replace the battery cells, reconstruct the battery backup system components, and reinstall the system within the aircraft. Currently such a process will require grounding the aircraft for at least twenty-four hours, and often times forty-eight to seventy two hours, as the backup system is removed, refurbished, and replaced to meet flight regulations and requirements. Although it is possible to replace a faulty system with a new battery backup system, it is generally cost prohibitive to maintain a “spare” system either on board the aircraft or immediately available for replacement. For these reasons the standard operating procedure when a battery backup system is determined to be faulty (as indicated through failure of a voltage check), the aircraft is grounded for the period of time necessary to remove, refurbish and replace the battery backup system thereby taking the aircraft out of service, often at a point in time when it is most required for service. Aside from the scenario as stated above, the current emergency battery backup systems require a periodic check that is done in intervals of three months, six months, or one year. In most cases the current systems must be removed from the aircraft and sent to a service facility for this procedure. The service of the current systems require at least twenty four hours and many times much longer depending on the discrepancy if any. The current systems that do not have to be removed for the periodic check still must be removed if a fault is found. These systems will then incur the same aircraft down time as mentioned above for repair or replacement being at least twenty-four hours, and often times forty-eight to seventy two hours.

It would be desirable, therefore, to have a battery backup system capable of providing electrical power to aircraft equipment that is modular in structure and function so as to permit the easy testing and replacing of components within the system while it is in place in the aircraft. It would be desirable if such testing and replacement could occur without the necessity of grounding the aircraft for extended periods of time. It would be desirable if the battery cell components and the power supply control components of the system were modular in structure such that each could be separately removed from the system and replaced without the requirement of removing and replacing the entire battery backup system. It would be beneficial if the removal of the various modules described could be accomplished through a plug-in enclosure with hinged front panel access. It would further be beneficial if each module within the system could be separately tested within the aircraft to obtain a discrete operational status indication of a specific fault location, thereby determining which module, if any, required replacement.

### SUMMARY OF THE INVENTION

The present invention, therefore, provides a modular aircraft emergency backup battery system and methods for operating the system as well as individually removing and replacing the various modules within the system. The system includes a module cabinet enclosure that positions and interconnects the various modules that together make up the system. Aircraft interconnection is achieved through a connector assembly integrated within the cabinet enclosure to provide the necessary electrical connections to and from the aircraft that recharge the batteries and provide a source of power to the various systems when a battery backup is required. Additionally, the cabinet enclosure provides positioned connections for one or more battery cell modules and one or more power control circuitry modules.

The cabinet enclosure in the preferred embodiment positions and retains a hinged front panel that allows access to the previously described battery cell modules and power control circuitry modules. Separate test circuits with user activated switches and status indicators are provided in association with each of the modules. The battery cell module further may include battery cell heater components and a low voltage cutoff switch. The power supply control module includes a two stage charging circuit connected to the aircraft's power buss and optional AC inverters and/or DC converters to condition the output of the battery system.

Connections between the modules and between the system and the aircraft are provided by a connector assembly that may be integrated on a removable circuit board positioned within the cabinet enclosure. The modules are structured with aligned connector plugs mateable with the connectors positioned on the connector assembly circuit board. The modules are therefore capable of being slid into or out from the cabinet enclosure, connecting to or disconnecting from the connector assembly in the process.

In this manner, the overall system of the present invention provides a modular bay that itself is positioned in place of an existing avionics battery backup system and connects to the aircraft within the space typically occupied by such an existing system. Instead of requiring complete removal, bench testing, servicing, and replacement, however, the present system allows testing and access to each of the modular components within the system and their individual replacement as necessary. The front panel components of the system (either fixed to the modules or connected through hinged placement) may incorporate many of the test circuit components and display indicators which allow the user to identify the operational status of each of the modular components within the system either on an ongoing basis or when a test is initiated through activation of the test circuitry by the user.

Although a variety of structural configurations are anticipated based upon the existing configurations for integrated avionics battery backup systems, the basic modular configuration of the present invention and the methods associated with the operation, testing, and replacement of these modules, is consistent throughout the various configurations. In other words, although there are currently several different configurations for emergency backup battery systems in aircraft, the modular construction and function of the present invention lends itself to use and application with each.

### BRIEF DESCRIPTION OF THE DRAWINGS

FIG. 1 is a perspective view of a typical application of a first preferred embodiment of the present invention shown removed from the aircraft and partially disassembled to show the various modules.

FIG. 2 is an exploded perspective view of the module enclosure cabinet of the embodiment shown in FIG. 1 of the system of the present invention.

FIG. 3 is an exploded perspective view of the battery module of the embodiment shown in FIG. 1 of the system of the present invention.

FIG. 4 is an exploded perspective view of the power supply control module of the embodiment shown in FIG. 1 of the system of the present invention.

FIG. 5 is a cross-sectional view of the connector components of the system of the present invention showing the connections between the modules and between the enclosure and the aircraft.

FIG. 6 is a schematic block diagram showing the various sub-components of the system of the present invention as included in the power supply control module and the battery module.

FIGS. 7A-7D are flowcharts of the steps in the methodology of the present invention describing system installation, pre-flight testing procedures, in-flight monitoring, and module replacement.

### DETAILED DESCRIPTION OF THE PREFERRED EMBODIMENTS

As indicated above, there are currently in general use several emergency battery backup system configurations. The present invention provides a modular approach to the replacement of these systems that allows for a cost effective and convenient method for the replacement of the system components (modules). What follows is a detailed description of an implementation of the present invention in conjunction with one particular structural configuration associated with a first example of an existing avionics battery backup system. Those skilled in the art will recognize that the basic concepts provided by the present invention translate into configurations different from those disclosed in detail herein thereby making the present invention applicable to each of the various existing battery backup system configurations, as well as any future developed emergency battery backup systems incorporating the same basic components.

As indicated above, a primary objective of the present invention is to provide for the modular replacement of various sub-components, or modules, in the overall battery back-up system associated with aircraft avionics. The structures and functions, therefore, of the modules described below are directed to an ability to remove and replace individual modules and module components as opposed to the necessity of removing, testing, repairing, and replacing the system as a whole.

Once again, it is noted that the designs, structures, geometries, and even specific components described below are characteristic of a first type of avionics battery back-up system that functions in a manner similar to the various other types of systems even though it may structurally differ in appearance and component arrangement. Those skilled in the art will recognize that the basic structures, modules, and components described herein below may translate easily into alternate structures and arrangements without departing from the underlying inventive concept of modular component replacement and the methods associated therewith.

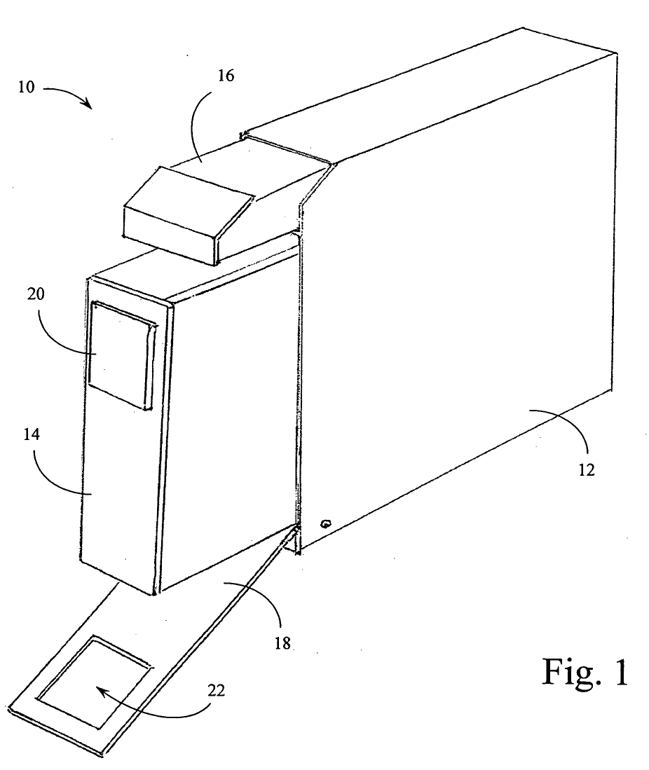

Reference is made first to FIG. 1 for a brief description of the overall system of the present invention and its modular construction. FIG. 1 discloses emergency battery back-up system 10 comprising cabinet enclosure 12 into which are inserted and positioned battery module 14 and power supply control module 16. The manner in which these modules 14 and 16 are inserted into and held within cabinet enclosure 12 is described in more detail below.

Cabinet door cover 18 is hingedly positioned on cabinet enclosure 12 in a manner that allows access to and removal of battery module 14 and to some extent, power supply control module 16. The manner of attachment of cabinet door cover 18 to cabinet enclosure 12 is described in more detail below. A display panel 20 is positioned on battery module 14 for purposes of initiating module testing and displaying test results and the like, again as described in more detail below.

Cabinet enclosure 12 is structured so as to be mounted in place of the existing emergency battery back-up systems in certain aircraft configured for this particular structural embodiment. Previously, the replacement of any or all components associated with an emergency battery back-up system would require the removal of the complete system from the aircraft. As indicated above, the expense of the complete system was generally too high to maintain a spare system available to immediately replace the system being removed. In other words, if the emergency battery back-up system failed its test (a test that was generally not specific as to the components which failed), the entire system had to be removed and taken to a test bench set up where the specific fault associated with the system failure was identified. This testing period generally took at least twenty-four hours and often times forty-eight to seventy-two hours, during which the aircraft could not fly. System 10 as shown in FIG. 1 is intended to replace the system that previously had to be removed in its entirety from the aircraft and taken to a remote site for testing and repair. As can be seen in FIG. 1, the present invention provides a number of removable components, each of which may undergo separate testing to identify functionality and operational status and to permit the removal and replacement of individual modules rather than the entire system. Individual modules may either be readily available on the aircraft or in nearby locations such that the aircraft need not be kept on the ground for any significant length of time. The general length of time required to remove and install the modules on the present invention is approximately ten to fifteen minutes, thus making the aircraft airworthy in a significantly shorter period of time. The present system allows for repair and replacement of the modules either on the aircraft (as would be generally preferred) or off of the aircraft if circumstances warrant it.

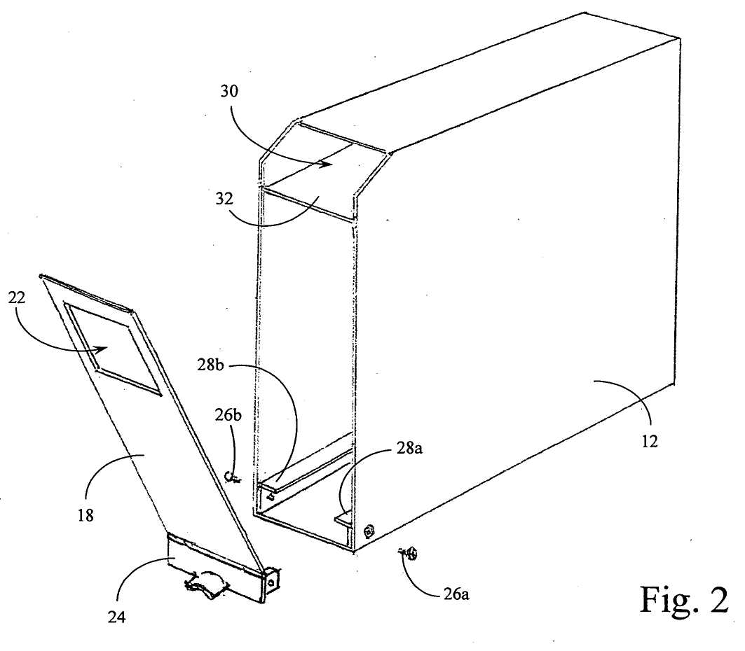

Reference is now made to FIG. 2 for a more detailed description of cabinet enclosure 12, its various components, and the manner in which it retains and holds battery module 14 and power supply control module 16. Cabinet enclosure 12 is a shell which essentially defines two compartments, one for receiving the battery module, and one for receiving the power supply control module. Each of these modules 14 and 16 engage connectors (not shown in FIG. 2) positioned on an interior rear panel of cabinet enclosure 12. Hinged cabinet door cover 18 is attached to cabinet enclosure 12 by means of hinge bracket 24. Bracket 24 is attached on either side of the base of cabinet enclosure 12 with attachment screws 26a and 26b. Hinge bracket 24 is hingedly connected to cabinet door cover 18 in a manner that allows door cover 18 to cover battery module 14 once it has been positioned within cabinet enclosure 12. Various mechanisms (magnetic latches, detent latches, or other mechanisms) for maintaining door cover 18 in an upright and closed position are anticipated.

Interior to cabinet enclosure 12 are positioned battery module rails 28a and 28b. These rails support and guide the insertion of battery module 14 as it is incorporated into cabinet enclosure 12. In a similar manner, divider panel 32 supports and positions power supply control module 16 as it is inserted into the control module enclosure space 30 above the placement of battery module 14. Each of the enclosure compartments thus defined provides the space necessary to accommodate the modules and allow for their easy insertion and removal as well as aligning them for proper plug connection.

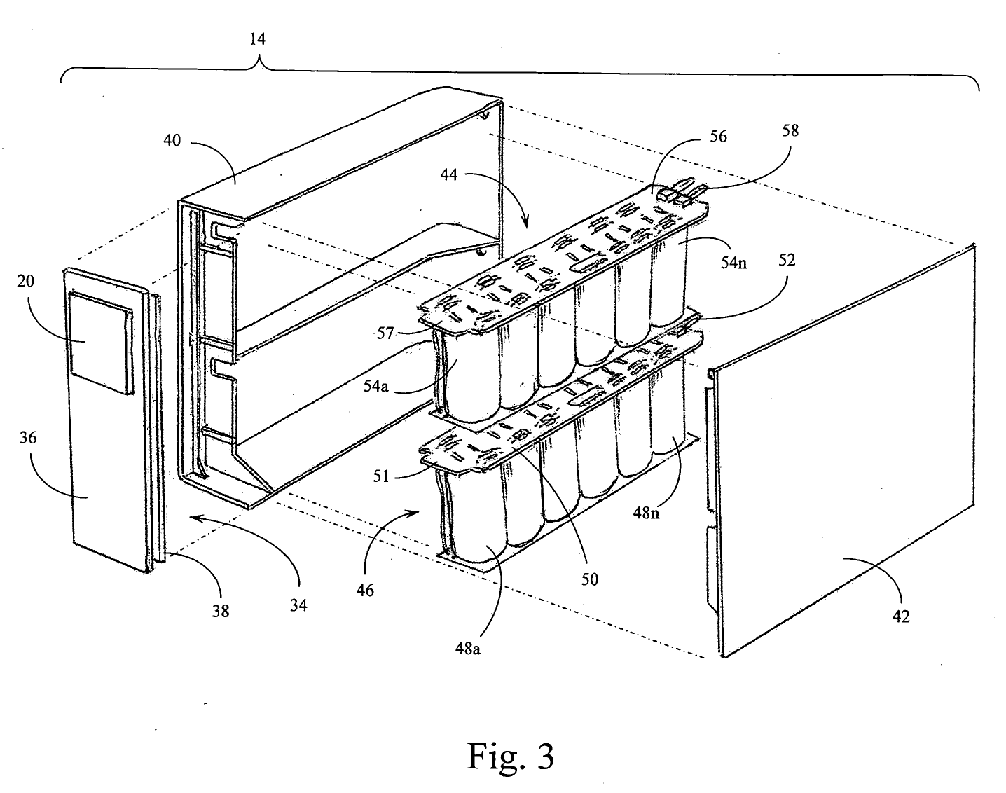

Reference is now made to FIG. 3 for a more detailed description of the components of battery module 14. In this view it can be seen that battery module 14 is comprised of five primary sub-components which when assembled make up the battery module as a whole. Module enclosure shell 40 receives and supports each of two individual battery cell and heater assemblies 44 and 46. Module cover 42 is positioned over both battery cell and heater assemblies 44 and 46 once they have been inserted into module enclosure shell 40. Battery module front panel 34 comprises face plate 36 and circuit board 38. Circuit board 38 incorporates components viewable through display panel 20 in a manner described in more detail below. Front panel 34 is attachable to the combined sub-components of the battery module described above. In this manner and as indicated in FIG. 3, battery cell and heater assemblies 44 and 46 are held stationery and secure within module enclosure shell 40 and module cover 42.

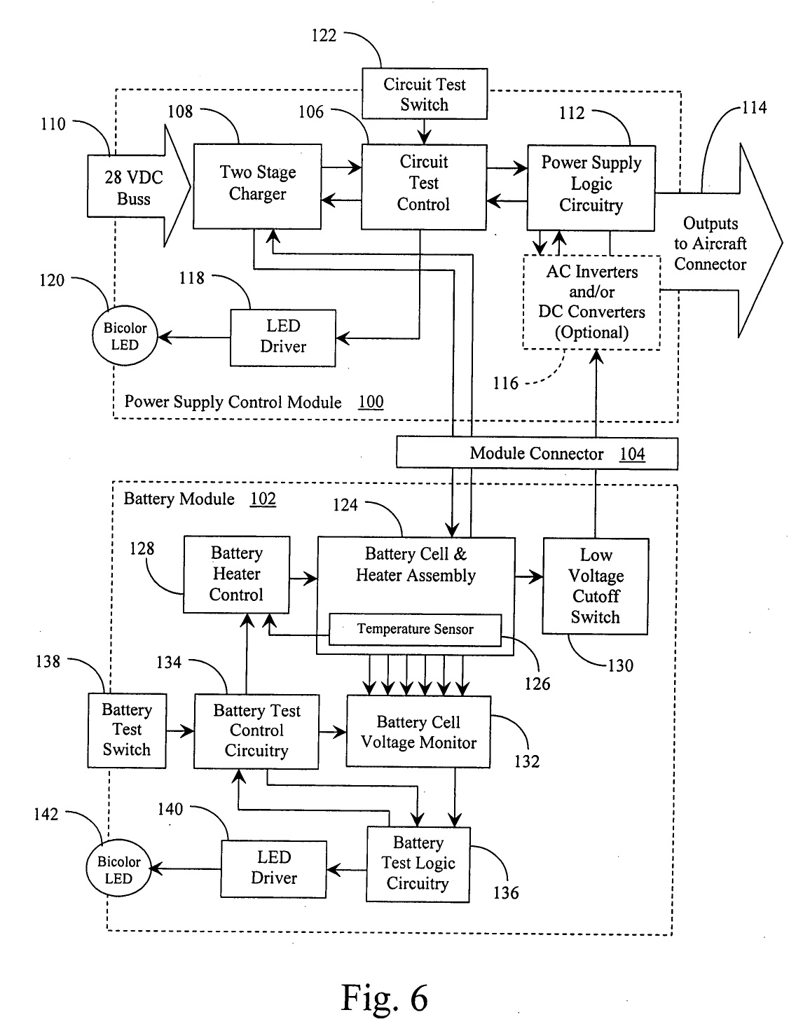

Connectors extending from circuit boards, which retain and position the individual battery cells, extend through apertures on the back face of module shell 40 to connectors positioned within the cabinet enclosure, again as described in more detail below. Each of the two battery cell and heater assemblies 44 and 46 are comprised of an array of battery cells and top panel circuit boards to which the battery cells are attached. Battery cell and heater assembly 46 is comprised in this instance of battery cells 48a-48n which are positioned and connected together (physically and electrically) by way of circuit board 50. Also incorporated on circuit board 50 are the various electronic components necessary for maintaining the battery cells in usable condition. These components are described in more detail below with respect to FIG. 6. Connectors 52 are positioned on the rear edge of circuit board 50 and extend through apertures in module enclosure shell 40.

In similar fashion, battery cell and heater assembly 44 is made up of battery cells 54a-54n which are connected together (physically and electrically) by circuit board 56. Connectors 58 likewise make the necessary electrical connections between circuit board 56 and the remaining components within the system of the present invention in the manner described above.

The system of the present invention benefits in part from the availability of a number of different sealed rechargeable batteries for emergency backup purposes. A wide variety of rechargeable batteries may be used in the configurations described herein, including sealed lead-acid, lead-acid gel, nickel-cadmium, nickel metal hydride, lithium ion, lithium ion polymer, nickel-zinc, and rechargeable alkaline. In addition, the module configurations shown and described may contain any number of batteries, depending on size and capacity. The modules shown containing six cells are provided as examples only. Further, some rechargeable battery cells are available in “pre-packaged” groups instead of discrete cells which may likewise be configured into the modules described herein.

Each of battery cell and heater assemblies 44 and 46 are positioned in and retained in shelf arrangement within module enclosure shell 40. In addition to connectors 52 and 58 extending through apertures in the rear of module enclosure shell 40, edge connectors 51 and 57 extend through appropriately configured apertures in the front of module enclosure shell 40. These front edge connectors 51 and 57 mate with connectors positioned on circuit board 38 attached to front panel 34. Between circuit board 38 and circuit boards 50 and 56, the various components, again described in more detail below, associated with battery module 14 are all positioned and interconnected.

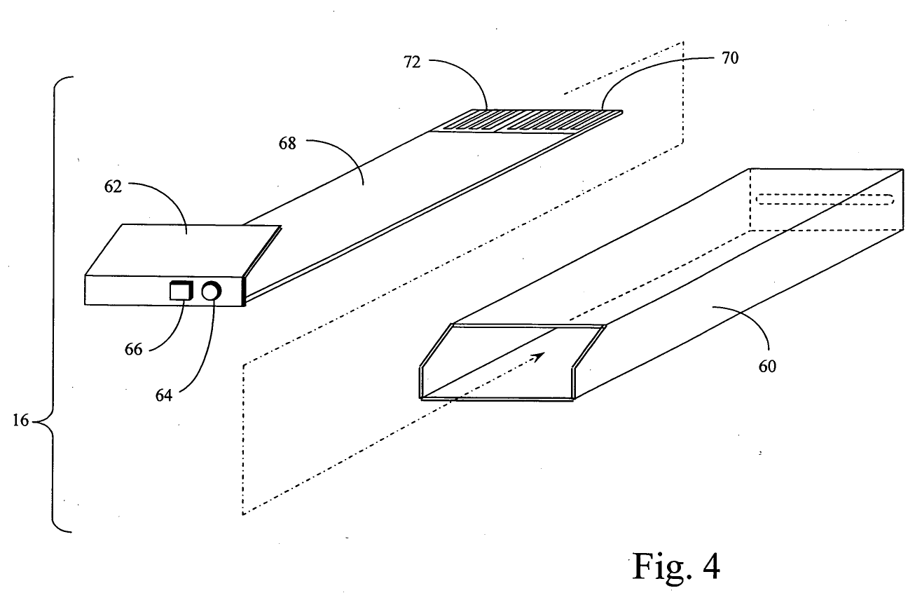

Reference is now made to FIG. 4 for a detailed description of the power supply control module 16 and its various sub-components. Power supply control module 16 is primarily made up of module enclosure 60 and circuit board 68. Module enclosure 60 includes an angled front panel 62 which on its forward face retains push-button switch 66 and LED indicator 64. Front panel 62 can be configured to cover these electronic components (switch 66 and LED 64) as they are mounted on circuit board 68 along a forward edge thereof. Circuit board 68, in the preferred embodiment, is fixed to front panel 62 so as to be removable from within module enclosure 60. On a rearward edge of circuit board 68 are positioned edge connectors 70 and 72 which provide module connection to battery module 14 as well as outputs and inputs to and from the aircraft as described below.

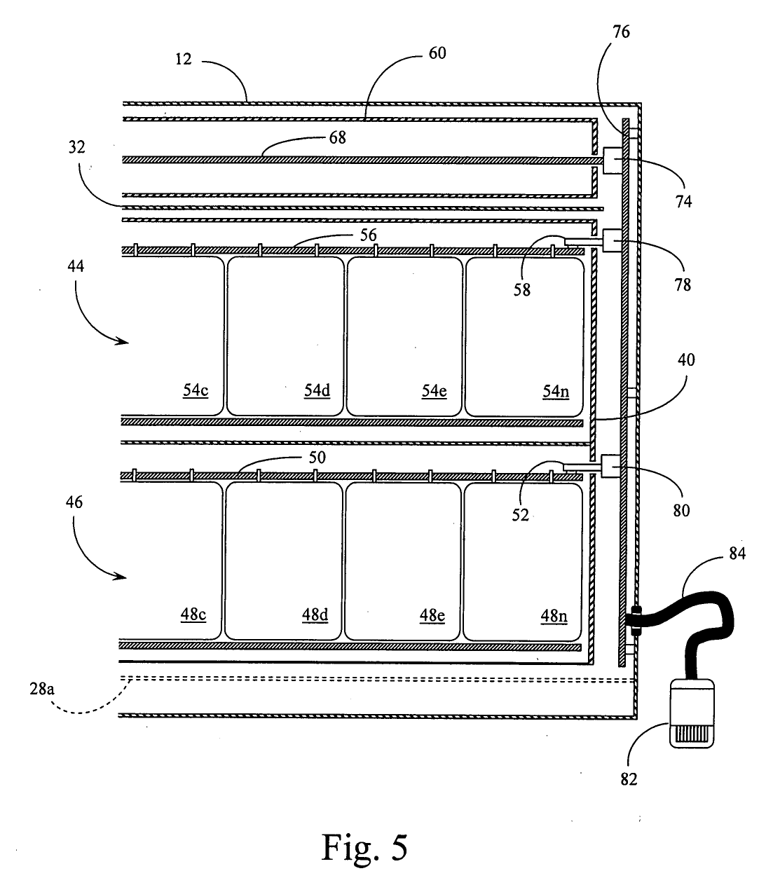

Reference is now made to FIG. 5 for a detailed description of manner in which the various modules described above connect to and are electrically integrated into the overall system of the present invention as well as with the aircraft itself. FIG. 5 discloses an elevational cross-sectional view that includes not only cabinet enclosure 12, but power supply control module 16 (by way of its enclosure 60) and battery module 14 (by way of its enclosure 40). Positioned within battery module enclosure shell 40 are battery cell and heater assemblies 44 and 46, retained as they are within the shelf-like structures of battery module enclosure shell 40. Likewise, power supply control module 16 is shown positioned and supported within the upper chamber 30 of cabinet enclosure 12.

Three sets of connections are made on circuit board 76 positioned on the inside face of the back panel of cabinet enclosure 12. Circuit board 76 provides the conductive paths between a short external wiring harness 84 and the various edge connectors described in above in association with power supply control module 16 and battery module 14. Edge connectors 70 and 72 of power supply control module 16 are aligned so as to be inserted into connector 74 mounted on circuit board 76 positioned on the back panel of cabinet enclosure 12 as indicated. In similar fashion, connectors 58 and 52 on battery cell and heater assemblies 44 and 46 respectively are positioned to be received into connectors 78 and 80, again mounted on and positioned on circuit board 76 positioned on the back panel of cabinet enclosure 12, again as shown in FIG. 5. Wiring harness 84 extends from circuit board 76 and comprises electrical conductors that provide both the connections to the electrical outputs to the aircraft as well as inputs from the 28 VDC buss. Circuit board 76 provides connections between power supply control module 16 and the battery module 14.

It will be recognized by those skilled in the art that the arrangement of connectors shown in FIG. 5 may alternatively involve individual connectors positioned through apertures on the rear panel of cabinet enclosure 12 or may involve the connector circuit board positioned within cabinet enclosure 12 across the interior face of the back panel thereof as shown. Conductors on the circuit board 76 electrically connect the battery module and the power supply control module to each other, as well as connect to a short wiring harness that extends simply from the integrated connector board. In either case, the function of the electrical connections shown in FIG. 5 is to provide the necessary connections between the battery module and power supply control module and the necessary connections between the avionics battery back-up system as a whole and the aircraft.

Reference is now made to FIG. 6 for a detailed description of the various electronic components associated with each of the modules described above and the manner in which they permit the modular functionality of the overall system. In FIG. 6, power supply control module electronics 100 is shown configured separately from battery module electronics 102. Connecting these two electronic systems is module connector 104. As indicated above, module connector 104 may simply be the combination of connectors associated with the circuit board positioned on the back panel of cabinet enclosure 12 that allow for the connection between the modules. Connections to the aircraft are primarily made through outputs to aircraft connector 114 and the 28 VDC buss 110 shown in association with power supply control module 100.

The electronic components associated with power supply control module 100 are primarily contained within three circuitry elements. These include circuit test control 106, power supply logic circuitry 112, and two-stage charger 108. Two-stage charger 108 receives voltage from the aircraft 28 VDC buss 110 as shown. This voltage is provided through two-stage charger 108 to the battery module 102 as described in more detail below. Control over this charging process is maintained by the two stage charger 108 and battery cell voltages received from the battery cell and heater assembly 124. Optionally incorporated into power supply control module 100 may be AC inverters and/or DC converters 116 as necessary to match the electronic and electrical systems of the aircraft to the electronic and electrical systems of the avionics battery back-up system. The AC inverters and/or DC converters 116 provide this functionality through power supply logic circuitry 112 and through other direct connections through modular connector 104 to battery module 102.

Power supply control module 100 insofar as it is separately removable and replaceable, incorporates its own test circuitry and diagnosis capability. This is initiated by circuit test switch 122 which, through circuit test control 106 confirms the operational status of the various electronic components within the system and directs a displayed response through LED driver 118 and indicator LED 120. Indicator LED 120 is designed to indicate a red color if a fault is detected within the power supply control module circuitry and to illuminate green when the electronic circuits are nominally functional.

Battery module 102 as shown in FIG. 6 and as described in part above is comprised primarily of battery cell and heater assembly 124 which in the embodiment shown in the above figures comprises an array of twelve battery cells arranged in two banks of six cells. Integrated in association with battery cell and heater assembly 124 is temperature sensor 126. This temperature sensor 126 provides an input into battery heater control 128 which activates the heater elements of battery cell and heater assembly 124 to maintain the batteries at optimal temperatures for their charging and discharging functionality. Low voltage cut-off switch 130 monitors the voltage level of the battery cells and cuts off battery output when the voltage drops below a pre-set level. This low voltage condition might occur during an excessive drain during active use or may result from an inadvertent drain occurring while the aircraft is on the ground.

Overall the battery cell and heater assembly 124 is monitored for the voltage and current capacity of the battery cells by battery cell voltage monitor 132 which is individually connected to each of the cells within the assembly 124. Operation of the test circuitry associated with battery module 102 is carried out through battery test control circuitry 134. Activation of battery test control circuitry 134 is accomplished from battery test switch 138 which extends from battery module 102 through the display panel described above. Battery test logic circuitry 136 receives the resultant output from battery test control circuitry 134 and from battery cell voltage monitor 132 so as to appropriately drive indicator LED 142 through LED driver 140. As with the power supply control module 100 described above, the indicator LED is intended to provide a green light indicator of the good or nominal status of battery module 102, a yellow light indicator for low charge condition within battery module 102, and a red light indicator of a fault within battery module 102. Those skilled in the art will recognize that the basic circuitry shown and described in FIG. 6, especially such circuitry associated with battery module 102, may be further refined such that individual battery cells within the system may be tested and monitored.

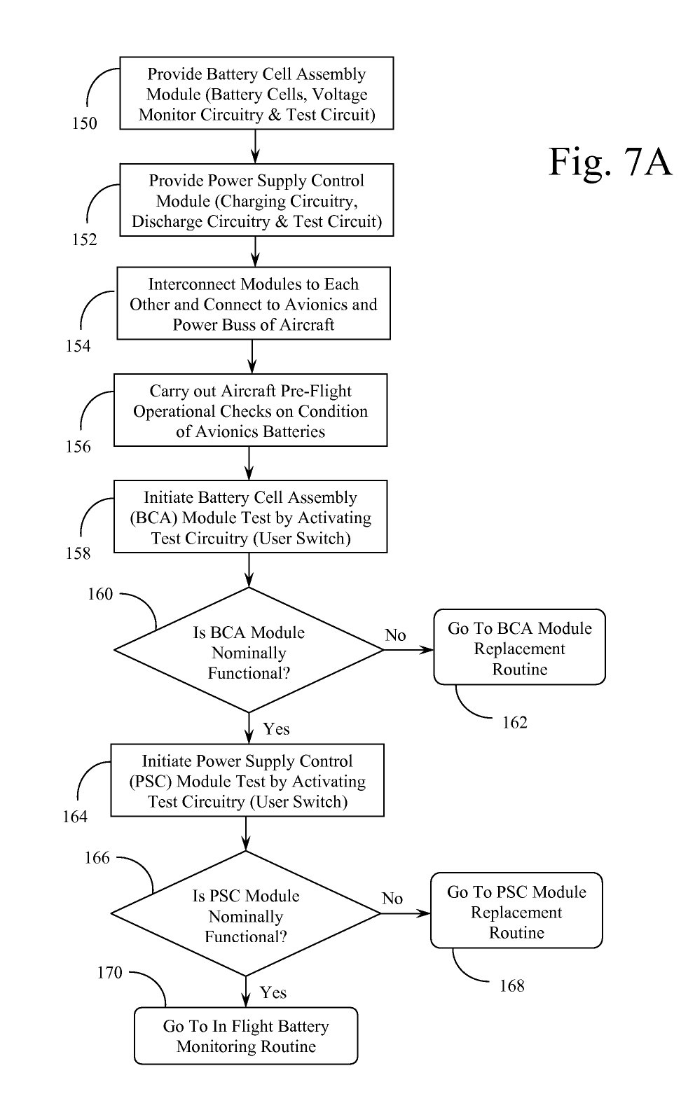

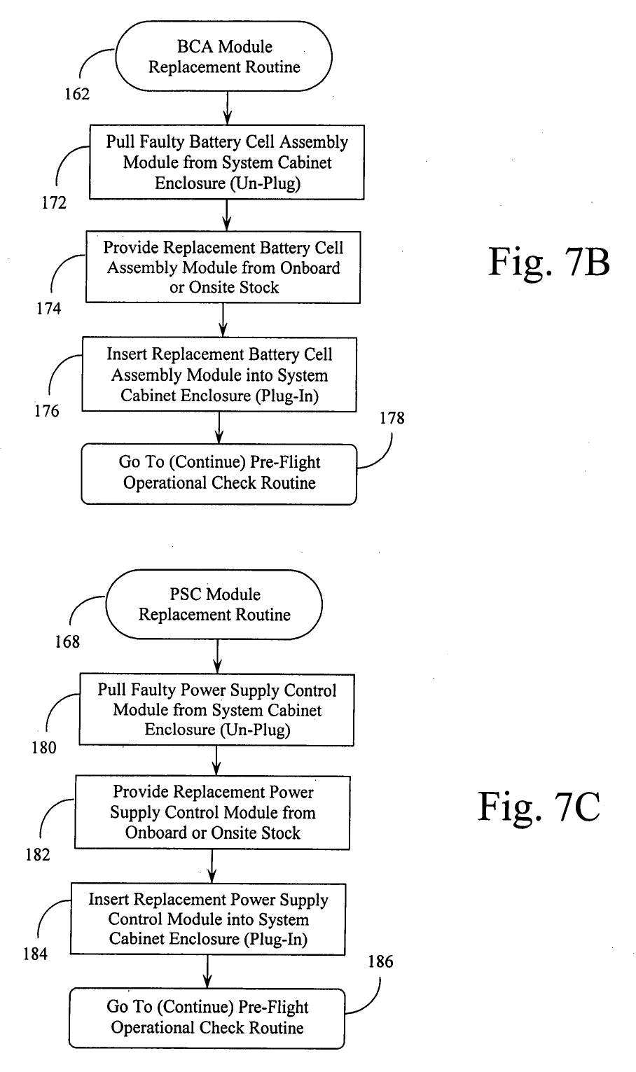

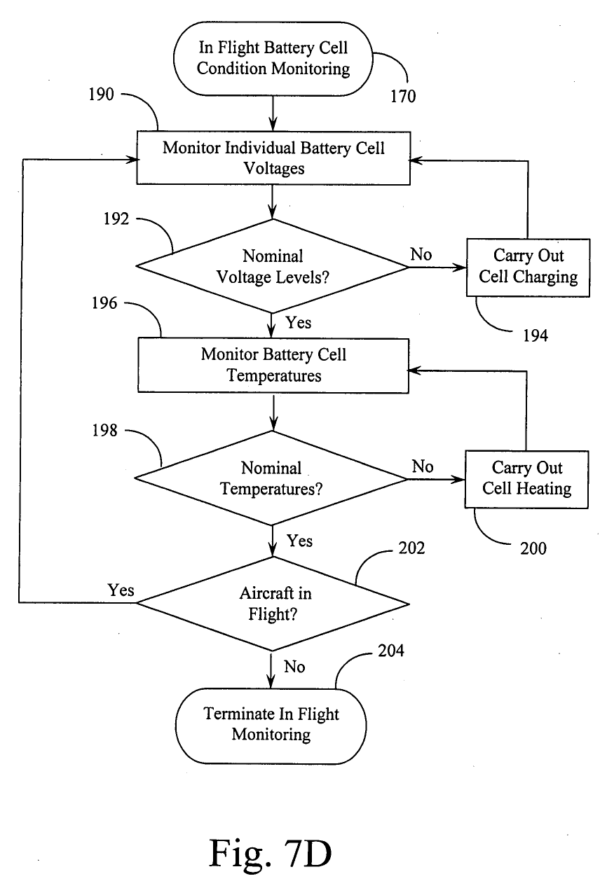

FIGS. 7A-7D provide flowcharts of the generic (applicable to all structural embodiments) steps in the methodology of the present invention describing system installation, pre-flight testing procedures, in-flight monitoring, and module replacement. FIG. 7A provides the steps associated with installation of the system and the basic pre-flight testing that is carried out. Step 150 involves providing the Battery Cell Assembly (BCA) Module, essentially as described above. Step 152 involves providing the Power Supply Control (PSC) Module, again essentially as described above. Step 154 involves providing the interconnections between the modules and the avionics and power buss of the aircraft. The process then, at Step 156, involves carrying out the preflight check of the condition of the battery backup system. This process includes, at Step 158 initiating the BCA module test by activating the test circuitry switch. Step 160 then queries whether the module is nominally functional (as indicated by the LED indicator). If not, then at Step 162, the process proceeds to the BCA module replacement routine.

If the BCA function is nominal, then at Step 164 the process continues with initiating the PSC module test by activating the test circuitry switch therein. Step 166 then queries whether the module is nominally functional (as indicated by the LED indicator). If not, then at Step 168, the process proceeds to the PSC module replacement routine. If the PSC function is nominal, then at Step 170 the process continues with the in-flight battery monitoring activities.

FIG. 7B provides the basic process associated with replacement of the BCA module as initiated at Step 162. One objective of the present invention is to make this process simpler and more cost effective. At Step 172 the user pulls the faulty battery cell assembly (BCA) module from the system cabinet enclosure, disconnecting the electrical connectors from the matching connectors on both the front panel (which has been pivoted down to provide access) and the back panel. At Step 174, a replacement BCA module is provided, either from onboard “spare part” storage or from on-sight (in hanger) stock. Alternately, these replacement modules may be stocked at and readily delivered from aircraft supply businesses near the airport. In any event, the objective is to make the aircraft ready to fly within a matter of a minutes rather than a matter of days.

The process of installing the replacement BCA module, at Step 176, involves the opposite of module removal, namely the insertion of the module into the cabinet enclosure to engage the connectors on the rear panel of the enclosure, followed by pivoting the hinged front panel back into place such that the connectors thereon are engaged and the display and switch elements are exposed. At this point, at Step 178, the process returns to the pre-flight operational check routine described above in FIG. 7A.

FIG. 7C provides the basic process associated with replacement of the PSC module as initiated at Step 168. As indicated above with replacement of the BCA module, one objective of the present invention is to make the module exchange process simpler and more cost effective. At Step 180 the user pulls the faulty power supply control (PSC) module from the system cabinet enclosure, disconnecting the electrical connectors from the matching connectors on the back panel. At Step 182, a replacement PSC module is provided, either from onboard “spare part” storage or from on-sight (in hanger) stock. Once again, these replacement modules may alternately be stocked at and readily delivered from aircraft supply businesses near the airport.

The process of installing the replacement PSC module, at Step 184, involves the opposite of module removal, namely the insertion of the module into the cabinet enclosure to engage the connectors on the rear panel of the enclosure. At this point, at Step 186, the process returns to the pre-flight operational check routine described above in FIG. 7A.

Finally, in FIG. 7D, the “normal” operational activities of the backup battery system are briefly described. At Step 170, the process of in-flight battery cell monitoring is initiated after the pre-flight system fault testing has determined the system to be operating nominally. Individual battery cell voltages are monitored at Step 190. Alternately, the cell bank voltage as a whole may be monitored or some sub-set of cells may be monitored as the cell configuration best permits. Step 192 queries whether the voltage is at a nominal (operational) level. If not then at Step 194 the system (through the PSC module) carries out the battery charging function from the voltage supplied from the aircraft 28 VDC buss (as described above).

If the battery cell voltages are nominal, then at Step 196 the battery temperatures are monitored. Aircraft batteries are subjected to temperature extremes at altitude and therefore benefit from being maintained at optimal operational temperatures through the use of heaters and the like. If at Step 198, the temperatures are determined to be below optimal range, the system carries out the battery heating function at Step 200. If the battery cell temperatures are nominal, then the system essentially determines, at Step 202, whether the aircraft is still in flight, and if so continues the in-flight battery cell monitoring routine. If the aircraft terminates its flight the system, as part of a broader shut down routine, terminates its in-flight monitoring routine at Step 204.

The methods described above are intended to include the primary (high-level) steps associated with the operation of the system of the present invention. Specific, more detailed, steps will be necessary in the processes described that may vary according to the type of cabinet enclosure and the structures of the included modules that are utilized. The functionality described therefore is intended to high-light the more important steps in the process of the present invention that together with the structural aspects of the invention, contribute to achieving the economy and efficiency that are among the objectives of the invention.

As indicated above, alternative structures for the avionics battery back-up system of the present invention are anticipated in order to match the connection and enclosure requirements associated with a variety of different aircraft structures. At the present time, there are generally several common geometries associated with emergency battery back-up systems for aircraft. Alternate embodiments, therefore, may incorporate different structures and geometries for the battery cell and heater assemblies described above and may, in fact, integrate these assemblies into a single unit. This would eliminate one or more of the connectors described above on the back panel of the system but otherwise would not modify the basic functionality of the system and its modular configuration. The characteristics of the above example that are essential to each of the alternative embodiments include the separation of the power supply control module from the battery module and the ability to separately test each module within the system in place in the aircraft.

Even though significant benefits are achieved with the system of the present invention through the ability to carry out testing and replacement of modules while the components are on the aircraft, the structures and functions of the system do not preclude its operation in a test bench environment. The structures of the present invention lend themselves to easy operation (testing, recharging, repairing, etc.) in any of the currently used off-aircraft facilities and environments. The system may therefore include a battery charging station that is separate from the aircraft to facilitate the preparation of the modules for use in the aircraft.

Although the present invention has been described in terms of the foregoing preferred embodiments, this description has been provided by way of explanation only, and is not intended to be construed as a limitation of the invention. Those skilled in the art will recognize modifications of the present invention that might accommodate specific prior art emergency battery backup replacement structures. Those skilled in the art will further recognize additional methods for utilizing the modular configuration of the present invention in a variety of different aircraft and emergency systems environments. Such modifications as to structure, orientation, geometry, and even component construction where such modifications are coincidental to the type of instrumentation present or the type of aircraft involved, do not necessarily depart from the spirit and scope of the present invention.

1. A modular battery system for use within an aircraft, the system comprising:
(a) a battery cell assembly module comprising at least one battery cell;
(b) a power supply control module comprising circuitry for charging the at least one battery cell and circuitry for allowing the discharge of the at least one battery cell to power the avionics of the aircraft; and
(c) a connector assembly comprising a plurality of electrical conductors and connectors between the battery cell assembly module, the power supply control module, and the aircraft avionics.

2. The system of claim 1 wherein the battery cell assembly module further comprises at least one battery heater.

3. The system of claim 1 wherein the battery cell assembly module further comprises a battery voltage monitor.

4. The system of claim 1 wherein the battery cell assembly module further comprises battery cell assembly test circuitry for verifying operational functionality of the battery cell assembly.

5. The system of claim 4 wherein the battery cell assembly test circuitry is user switch activated.

6. The system of claim 4 wherein the battery cell assembly test circuitry further comprises a visual indicator of the operational functionality of the battery cell assembly.

7. The system of claim 6 wherein the visual indicator comprises an indicator LED.

8. The system of claim 1 wherein the battery cell assembly further comprises a low voltage cutoff switch.

9. The system of claim 1 wherein the power supply control module further comprises power supply control test circuitry for verifying operational functionality of the power supply control module.

10. The system of claim 9 wherein the power supply control test circuitry is user switch activated.

11. The system of claim 9 wherein the power supply control test circuitry further comprises a visual indicator of the operational functionality of the power supply control module.

12. The system of claim 11 wherein the visual indicator comprises an indicator LED.

13. The system of claim 1 wherein the power supply control module further comprises AC inverter circuitry.

14. The system of claim 1 wherein the power supply control module further comprises DC converter circuitry.

15. The system of claim 1 wherein the connector assembly comprises a connector plug-in panel arranged to receive mateable connectors on the battery cell assembly module and the power supply control module.

16. The system of claim 15 wherein the connector plug-in panel further comprises a wiring harness and an end connector for connecting the system to the aircraft avionics and power buss.

17. The system of claim 1 further comprising a cabinet enclosure, the cabinet enclosure retaining the connector assembly and structured to receive and retain the battery cell assembly module and the power supply control module.

18. The system of claim 17 wherein the cabinet enclosure further comprises a plurality of rails for guiding the sliding insertion of the battery cell assembly module and the power supply control module into the cabinet enclosure.

19. The system of claim 17 wherein the cabinet enclosure further comprises a front panel, the front panel movable to allow the removal and insertion of the battery cell assembly module.

20. The system of claim 19 wherein the front panel is hingedly connected to a balance of the cabinet enclosure.

21. The system of claim 19 wherein the battery cell assembly module further comprises battery cell assembly test circuitry for verifying operational functionality of the battery cell assembly, the front panel comprises a circuit board configured with at least one connector mateable to at least one connection on the battery cell assembly module, and the battery cell assembly test circuitry is activated with a switch positioned on the front panel and an operational condition is indicated on a visual indicator positioned on the front panel.

22. A method for monitoring the condition of a modular avionics battery system in an aircraft and for removing and replacing individual modules within the system, the method comprising the steps of:
(a) providing a battery cell assembly module comprising at least one battery cell, a battery voltage monitoring circuit and a battery cell assembly test circuit;
(b) providing a power supply control module comprising battery cell charging circuitry, battery discharge circuitry, and a power supply control test circuit;
(c) connecting the battery cell assembly module through the power supply control module to the avionics system of the aircraft and the power buss of the aircraft;
(d) monitoring the charge condition of the at least one battery cell in the battery cell assembly module;
(e) periodically activating the battery cell assembly test circuit to determine the operational functionality of the battery cell assembly module;
(f) periodically activating the power supply control test circuit to determine the operational functionality of the power supply control module;
(g) on failure of the battery cell assembly module, removing and replacing the battery cell assembly module; and
(h) on failure of the power supply control module, removing and replacing the power supply control module;
wherein the removal and replacement of either the battery cell assembly module or the power supply control module may occur without the necessity of removing any other component of the avionics battery system.

23. The method of claim 22 wherein the step of periodically activating the battery cell assembly test circuit comprises the pre-flight steps of activating a user activated switch positioned on the battery cell assembly module and illuminating a visual indicator with either a good condition indication or a faulty condition indication.

24. The method of claim 22 wherein the step of periodically activating the power supply control test circuit comprises the pre-flight steps of activating a user activated switch positioned on the power supply control module and illuminating a visual indicator with either a good condition indication or a faulty condition indication.

25. The method of claim 22 wherein the battery cell assembly module is slidably positioned within a cabinet enclosure, the cabinet enclosure comprising the connectors for carrying out the step of connecting the battery cell assembly module and the power supply control module to each other and to the aircraft avionics, the step of removing the battery cell assembly module comprising pulling out and unplugging the module and slidably removing it from the cabinet enclosure.

26. The method of claim 22 wherein the power supply control module is slidably positioned within a cabinet enclosure, the cabinet enclosure comprising the connectors for carrying out the step of connecting the battery cell assembly module and the power supply control module to each other and to the aircraft avionics, the step of removing the power supply control module comprising pulling and unplugging the module and slidably removing it from the cabinet enclosure.
